(19) United States
(12) Patent Application Publication
(10) Pub. No.: US 2024/0172845 A1
(43) Pub. Date: May 30, 2024

(54) BUCKLE WITH WHISTLE

(71) Applicant: WOOJIN PLASTIC Co., Ltd., Namyangju-si (KR)

(72) Inventors: Ji Sook PAIK, Seoul (KR); Nan Hee PAIK, Seoul (KR); Ji Hye PAIK, Seoul (KR); Ji Won SON, Seoul (KR)

(73) Assignee: WOOJIN PLASTIC Co., Ltd., Namyangju-si (KR)

(21) Appl. No.: 18/386,133

(22) Filed: Nov. 1, 2023

(30) Foreign Application Priority Data
Nov. 24, 2022 (KR) 10-2022-0158940

(51) Int. Cl. A44B 11/26; A44B 11/00; G10K 5/00

(52) U.S. Cl. CPC A44B 11/266; A44B 11/005; G10K 5/00

(57) ABSTRACT

A buckle with a whistle includes: a plug member having lock arms extending forward from both sides of a base and a guide rod extending forward from the base in such a way as to be located between the lock arms; and a socket member having a chamber open on the front end thereof by means of an upper plate and a lower plate located to face each other so that the socket member is coupled to the plug member. The chamber is allowed to accommodate the guide rod therein. The guide rod is configured as the whistle. When the plug member is coupled to the socket member, the whistle is accommodated in the chamber.

### CROSS-REFERENCE TO RELATED APPLICATION

The present application claims priority to Korean Patent Application No. 10-2022-0158940 (Nov. 24, 2022), which is hereby incorporated by reference in its entirety.

### BACKGROUND

The present disclosure relates to a buckle, more specifically to a buckle with a whistle that is capable of allowing the whistle to be built therein, so that the buckle used to connect or fix belts or straps connected thereto has the inbuilt whistle to allow the whistle to be quickly and simply used when an emergency occurs, and that is capable of preventing foreign substances from entering the whistle to allow the whistle to be sanitarily used.

Generally, a buckle has been widely used to fasten belts or straps attached to a climbing backpack, a school bag, or the like, and goods using buckles are used mainly in the case where a user has outdoor activities.

That is, goods using buckles are widely found in various places during people's daily lives, and in the case of users enjoying hiking, boating, camping, climbing, and the like outdoors, they use goods to which a plurality of buckles are attached to fasten the straps or belts for various purposes.

On the other hand, various emergency situations, such as a situation in which an urgent rescue is requested, a situation in which a sound may not be transmitted far enough, a situation in which a person's voice many not be heard because of ambient noise, and the like, may occur during outdoor activities. Accordingly, it is desirable that the user participating in such outdoor activities carry a whistle for safety.

If a user breathes out into a whistle, air passes through an air passage (flue) of the whistle so that air vibrations are generated to produce a high sound. Therefore, the whistle is chiefly used as a tool that makes a sound signal to notify others of emergencies.

Such emergencies may occur to everybody, but most users do not expect that the emergencies happen to themselves. Accordingly, the user taking outdoor activities does not carry the whistle always. Therefore, because the user does not carry the whistle when the emergency occurs, he or she fails to notify others of his or her emergency situation so that he or she gets in an accident.

Patent literature 1 relates to a buckle having a whistle mounted thereon that is capable of being carried so that when an emergency occurs, the whistle can be easily used, and the buckle includes: a body fastened to the end of a belt; and a whistle detachably mounted on a sliding portion formed on one side of the body.

According to Patent literature 1, however, the whistle is fixedly coupled to an outer one end of the body in such a way as to protrude outward from the body, thereby undesirably increasing the entire volume of the buckle, and further, the protruding portion may be obstructed or even damaged when it touches other objects, thereby requiring the careful use for the buckle.

Patent literature 2 relates to a buckle with a whistle that is capable of allowing a guide rod located at the center of a plug member to be configured as the whistle, so that the plug member is coupled integrally to a socket member, without any change in the entire volume thereof. In this case, a whistle cap is disposed on the base of the plug member, and the whistle configured as the guide rod is separately made and then coupled to the plug member, thereby being complicated in manufacturing process and raising a manufacturing cost.

According to Patent literature 1 and Patent literature 2, further, if the whistle is mounted on the buckle and carried on a user's article, since the main portions of the whistle are exposed to the outside, they may be easily brought into contact with external objects, so that various dust and foreign substances may easily enter the whistle, thereby making the whistle unsanitary.

Therefore, there is a need for developing a new buckle capable of allowing a whistle to be simply built therein and ensuring the sanitary use of the whistle.

### PRIOR ART

Korean Patent No. 10-0995471 (Issued on Nov. 12, 2010)
Korean Patent No. 10-1990908 (Issued on Jun. 13, 2019)

### SUMMARY

Accordingly, the present disclosure has been made in view of the above-mentioned problems occurring in the related art, and it is an object of the present disclosure to provide a buckle with a whistle that is capable of allowing the whistle to be formed integrally therewith, being easily manufactured, and achieving the reduction of the manufacturing cost thereof.

It is another object of the present disclosure to provide a buckle with a whistle that is capable of allowing the whistle to be accommodated in a chamber of a socket member when a plug member is coupled to the socket member, so that the exposure of the main portions of the whistle to the outside is minimized to ensure the sanitary carrying and use of the whistle.

To accomplish the above-mentioned objects, according to the present disclosure, there is provided a buckle with a whistle that may include: a plug member having lock arms extending forward from both sides of a base and a guide rod extending forward from the base in such a way as to be located between the lock arms; and a socket member having a chamber open on the front end thereof by means of an upper plate and a lower plate located to face each other so that the socket member is coupled to the plug member, the chamber is allowed to accommodate the guide rod therein, wherein the guide rod may be configured as the whistle, and when the plug member may be coupled to the socket member, the whistle may be accommodated in the chamber.

According to the present disclosure, desirably, the chamber of the socket member may be divided into a central chamber for accommodating the guide rod therein and coupling chambers formed on both sides of the central chamber to insert the lock arms of the plug member thereinto.

According to the present disclosure, desirably, the central chamber and the coupling chambers of the socket member may be divided by means of partitions, and the inner top and bottom of the central chamber may face each other to form a guide groove therebetween so that the guide rod may be smoothly inserted into the central chamber through the guide groove.

According to the present disclosure, desirably, the whistle may include: the guide rod extending integrally from the base of the plug member, having a space portion formed therein, open on the front end portion thereof, and having air ventilation holes formed close to the front end portion thereof to allow the space portion to communicate with the outside; and a whistle cap fitted to the front end portion of the guide rod to allow a passage to be formed on a portion of the open front end portion of the guide rod.

According to the present disclosure, desirably, the guide rod may have slant inner surfaces formed on the inner surfaces of the front end portion thereof in such a way as to become enlarged outward therefrom and a locking projection protruding from the inner sides of the slant inner surfaces, and the whistle cap may have locking portions formed thereon correspondingly to the locking projections, so that the locking portions of the whistle cap may be pressurized against the locking projections of the guide rod to allow the whistle cap to come into close contact with the front end portion of the guide rod and be thus coupled to the guide rod.

According to the present disclosure, desirably, the plug member or the socket member may have a cross bar and a strap hooking bar selectively located on one side of a body thereof to connect a strap or belt thereto.

According to the present disclosure, desirably, the plug member or the socket member may have a rail holder located on one side of the body thereof.

According to the present disclosure, desirably, the plug member or the socket member may have a connection member, such as a ring, a clip, a loop, a fastening buckle, a strap connector, and the like, provided integrally with one side of the body thereof.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 is a perspective view showing a buckle with a whistle according to the present disclosure;

FIG. 2 is an exploded perspective view showing the buckle with a whistle according to the present disclosure;

FIG. 3 is an exploded perspective view showing the buckle with a whistle according to the present disclosure in a different direction from the direction of FIG. 2;

FIG. 4 is a perspective view showing a socket member of the buckle with a whistle according to the present disclosure;

FIG. 5 is a front view showing a state where the buckle with a whistle is in a separated state;

FIGS. 6A and 6B are side sectional views showing states where the buckle with a whistle is in separated and coupled states;

FIGS. 7A and 7B are front sectional views showing states where the buckle with a whistle is in separated and coupled states;

FIG. 8 is a perspective view showing a state where a whistle cap is separated from a plug member of the buckle according to the present disclosure;

FIG. 9 is a front sectional view showing a state where the whistle cap is separated from the plug member of the buckle according to the present disclosure; and

FIG. 10 is an exemplary view showing a state where the buckle with the whistle according to the present disclosure is mounted on a backpack.

### DETAILED DESCRIPTION

The present disclosure is disclosed with reference to the attached drawings, and in the description, the thicknesses of the lines or the sizes of the components shown in the drawing may be magnified for the clarity and convenience of the description.

Further, the terms as will be discussed later are defined in accordance with the functions of the present disclosure, but may be varied under the intention or regulation of a user or operator. Therefore, they should be defined on the basis of the whole scope of the present disclosure.

The example embodiments may be embodied in different forms and should not be construed as limited to the embodiments set forth herein but may be modified and variously implemented by those skilled in the art. If it is determined that the detailed explanation on the well known technology related to the present disclosure makes the scope of the present disclosure not clear, the explanation will be avoided for the brevity of the description.

A buckle applied to the present disclosure is mounted onto belts or straps attached to an article, such as a climbing backpack, a school bag, a helmet, and the like to connect or separate the belts or straps to or from each other, and to do this, the buckle consists of a plug member and a socket member detachable from each other.

The belts or straps are attached to the climbing backpack, the school bag, the helmet, and the like, and in the case of the climbing backpack, they are used as various purposes of shoulder straps, breast straps, and waist straps. Accordingly, the buckle according to the present disclosure may include all types of belts and straps connected to and separated from each other therethrough.

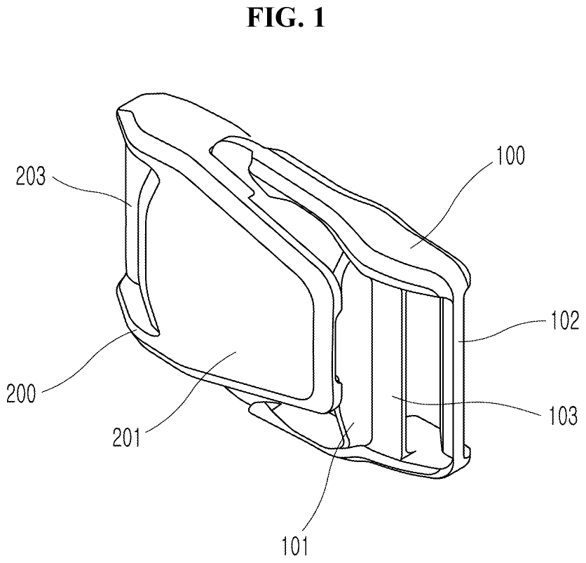

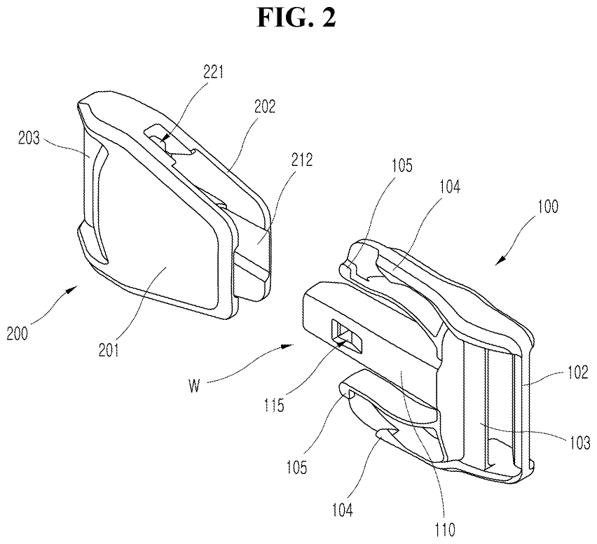

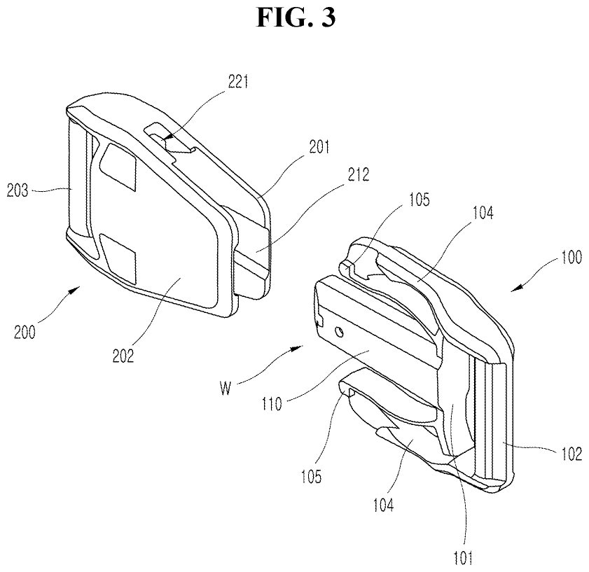

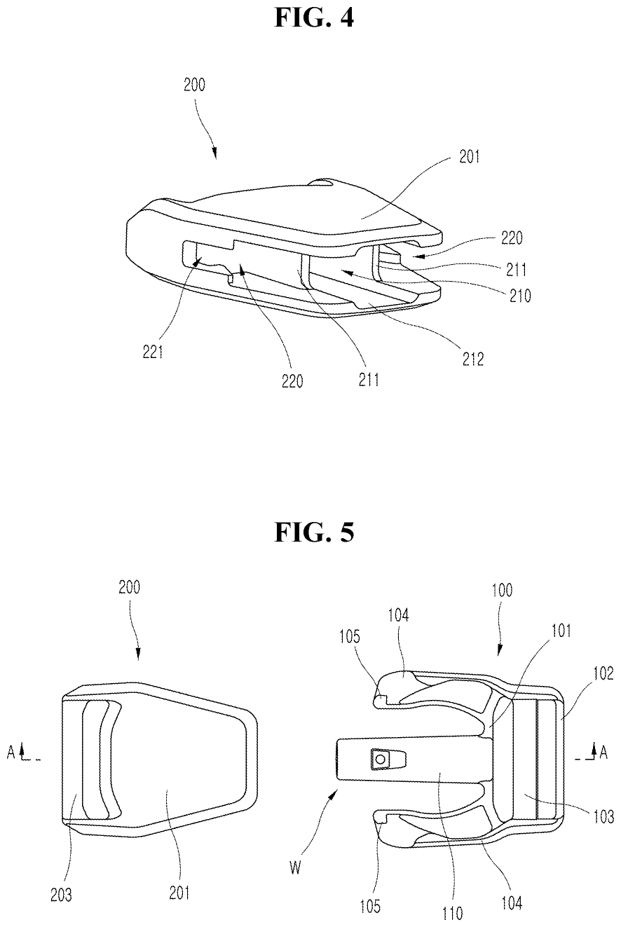

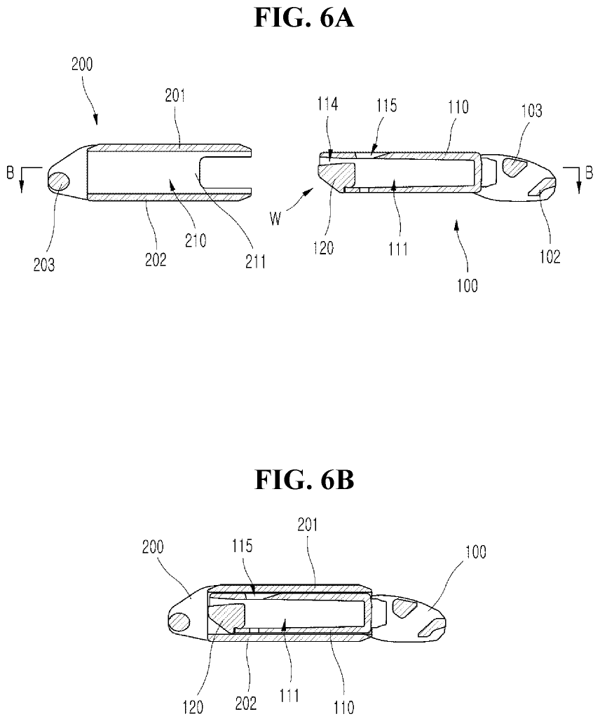

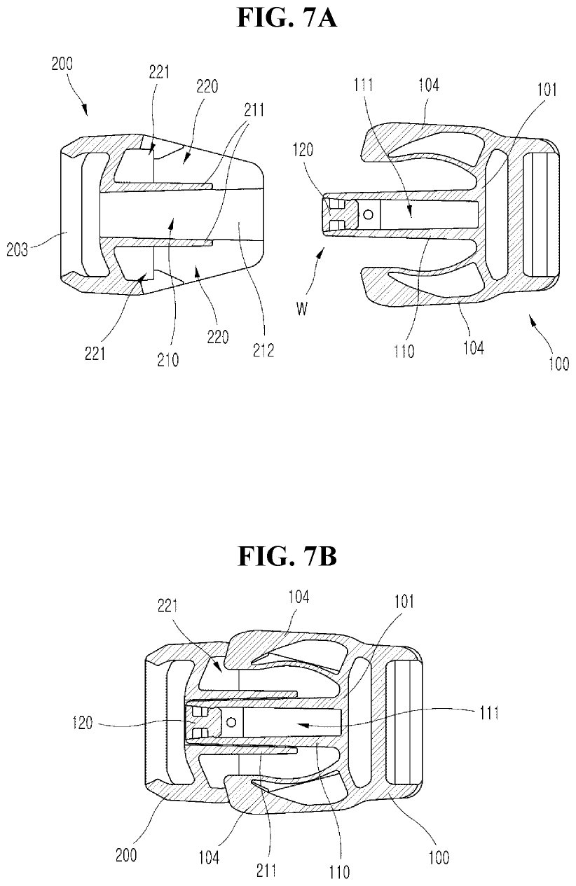

FIG. 1 is a perspective view showing a buckle with a whistle according to the present disclosure, FIG. 2 is an exploded perspective view showing the buckle with a whistle according to the present disclosure, FIG. 3 is an exploded perspective view showing the buckle with a whistle according to the present disclosure in a different direction from the direction of FIG. 2, FIG. 4 is a perspective view showing a socket member of the buckle with a whistle according to the present disclosure, FIG. 5 is a front view showing a state where the buckle with a whistle is in a separated state, FIGS. 6A and 6B are side sectional views taken along the line A-A of FIG. 5, wherein FIG. 6A shows a state where the buckle with a whistle is in a separated state and FIG. 6B shows a state where the buckle with a whistle is in a coupled state, and FIGS. 7A and 7B are front sectional views taken along the line B-B of FIG. 6, wherein FIG. 7A shows a state where the buckle with a whistle is in a separated state and FIG. 7B shows a state where the buckle with a whistle is in a coupled state.

Referring to FIGS. 1 to 7B, a buckle with a whistle according to the present disclosure is largely divided into a plug member 100 and a socket member 200.

The plug member 100 has a cross bar 102 and a strap hooking bar 103 formed transversely behind a base 101 in such a way as to lockedly wind the free end portion of a strap, and accordingly, the strap is crossingly wound on the cross bar 102 and the strap hooking bar 103 to adjust the length of the strap. Otherwise, only the cross bar 102 is provided to wind the free end portion of the strap thereon in such a way as to allow the free end portion to be fixed thereto by means of sewing.

Further, the plug member 100 has lock arms 104 extending forward from both sides of the base 101 in the same direction as each other, and the lock arms 104 are symmetrically shaped to each other with respect to the central portion of the plug member 100 and extend from the base 101, while having a thin thickness, in such a way as to be elastically bent around the base 101. Further, each lock arm 104 has a coupling protrusion 105 formed on the front end portion thereof in such a way as to be coupled to the socket member 200, and the outer surfaces of both lock arms 104 serve as pressurized portions for separating the plug member 100 from the socket member 200.

The coupling protrusions 105 may be formed on the middle portions of the lock arms 104 according to the mutual configuration to the socket member 200.

Further, the plug member 100 has a guide rod 110 extending forward from the center of the base 101 between the lock arms 104 in the same direction as the lock arms 104.

The guide rod 110 has an empty space portion 111 formed therein to provide an air passage and is open at the front end portion thereof in such a way as to be coupled to a whistle cap 120, so that the guide rod 110 is configured as a whistle W.

The guide rod 110 is desirably formed integrally with the base 101, and otherwise, the guide rod 110 may be separately made from the base 101 and then coupled to the base 101.

The guide rod 110 is desirably formed longer than both side lock arms 104 so that it can be used as the whistle W.

The socket member 200 is open on the front end thereof by means of an upper plate 201 and a lower plate 202 located to face each other to form a chamber adapted to guide and accommodate the plug member 100 therein, and further, the socket member 200 has a socket member cross bar 203 formed transversely on the rear portion thereof to fix the free end portion of the other strap thereto.

Further, the socket member 200 has a strap hooking bar, in the same manner as the plug member 100, to adjust the length of the other strap.

The chamber of the socket member 200 is divided into a central chamber 210 formed on the center thereof and coupling chambers 220 formed on both sides thereof.

The central chamber 210 and the coupling chambers 220 are spaces in which the guide rod 110 and the lock arms 104 are insertedly accommodated when the socket member 200 is coupled to the plug member 100.

The central chamber 210 and the coupling chambers 220 are divided by means of partitions 211, and the partitions 211 serve as frames for maintaining the entire strength inside the socket member 200.

The central chamber 210, which is a space in which the guide rod 110 of the plug member 100 is insertedly accommodated, induces the guide rod 110 to be smoothly inserted thereinto. To do this, the central chamber 210 desirably has the sectional shape corresponding to the sectional shape of the guide rod 110.

Further, the inner top and bottom of the central chamber 210 face each other to form a guide groove 212 therebetween so that the guide rod 110 is more smoothly inserted into the central chamber 210 along the guide groove 212. In this case, the corners of the guide groove 212 are curvedly formed, and the corners of the guide rod 110 are curvedly formed, so that the smooth contact between the guide groove 212 and the guide rod 110 can be made.

The coupling chambers 220 are the spaces in which the lock arms 104 of the plug member 100 are insertedly coupled and have concave coupling portions 221 formed therein in such a way as to be coupled to the coupling protrusions 105 of the lock arms 104.

The lock arms 104 are inserted into the coupling chambers 220 and thus coupled to the coupling chambers 220 by means of elastic motions, and in this case, the coupling chambers 220 are open on the outer surfaces thereof to allow the lock arms 104 to be smoothly inserted and operated thereinto.

Further, the guide rod 110 itself of the plug member 100 is configured as the whistle W, and to form the whistle W, the guide rod 110 is open on the front end portion thereof in such a way to allow the whistle cap 120 to be coupled to the front end portion thereof.

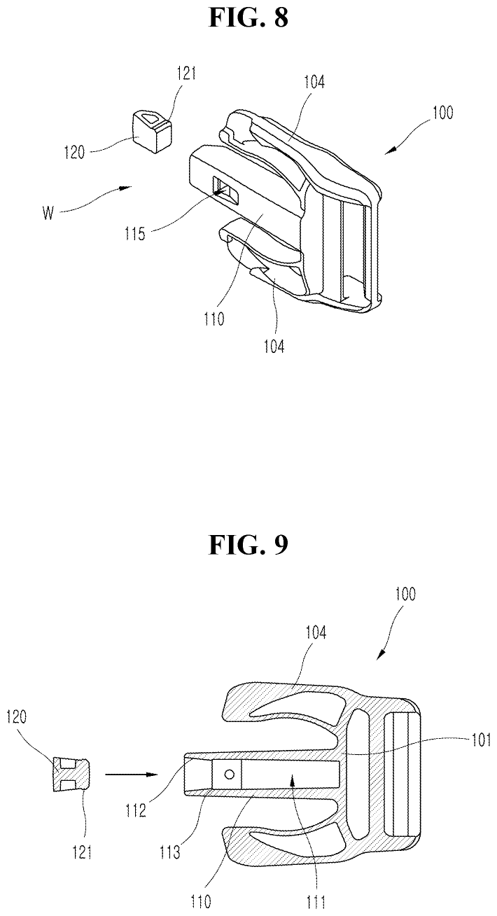

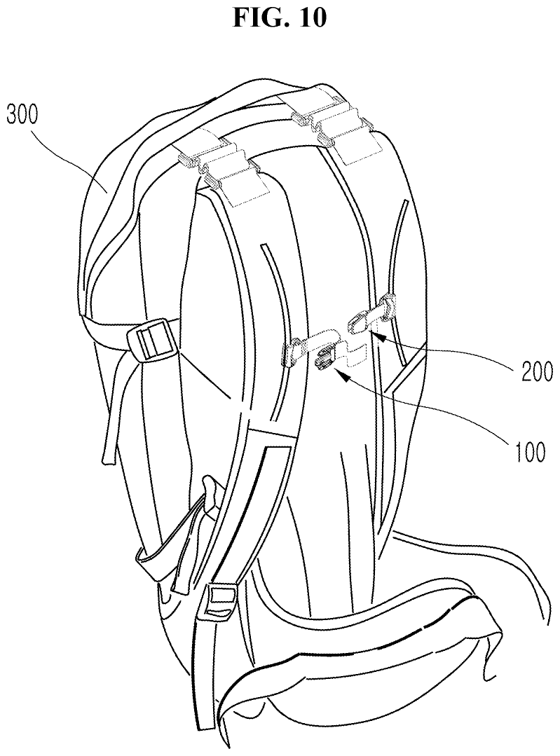

As shown in FIGS. 8 and 9, the whistle cap 120 as a separate part is coupled to the guide rod 110.

The guide rod 110 has slant inner surfaces 112 formed on the inner surfaces of the front end portion thereof in such a way as to become enlarged outward therefrom and locking projections 113 protruding from the inner sides of the slant inner surfaces 112, and further, the whistle cap 120 has locking portions 121 formed thereon correspondingly to the locking projections 113, so that when the locking portions 121 are pressurized against the locking projections 113, the whistle cap 120 comes into close contact with the front end portion of the guide rod 110 and is thus coupled to the guide rod 110.

The outer surfaces of the whistle cap 120 have slant outer surfaces coming into contact with the slant inner surfaces 112, and when the whistle cap 120 is coupled to the front end portion of the guide rod 110, a passage 114 as a gap for a wind passage is formed along one end of the whistle cap 120 and the inner surface of the guide rod 110.

The passage 114 becomes narrow toward the inside of the guide rod 110, and at a portion where the end of the passage 114 is formed, air ventilation holes 115 are formed on the guide rod 110.

The air ventilation holes 115 are formed on both facing ends of the guide rod 110 and have various sectional shapes for forming the wind passage.

As a result, the whistle W is formed on the front end portion of the guide rod 110, and accordingly, if air blows through the front end portion of the guide rod 110, that is, the passage 114 on the portion where the whistle cap 120 is coupled, a high sound is generated by a strong flow of air through the passage 114, the inner space portion 111 of the guide rod 110, and the air ventilation holes 115.

If the plug member 100 is initially fitted to the socket member 200, the lock arms 104 of the plug member 100 are inserted into both side coupling chambers 220 divided by the partitions 211, and the guide rod 110 constituting the whistle W is guided by the guide groove 212 and inserted into the central chamber 210.

Next, the coupling protrusions 105 of the lock arms 104 are elastically coupled to the concave coupling portions 221 in the coupling chambers 220 so that the plug member 100 is completely coupled to the socket member 200.

In such a coupled state, the base 101 of the plug member 100 is located at the entrance of the chamber, and in this case, the guide rod 110 is completely accommodated in the central chamber 210.

When the plug member 100 is coupled to the socket member 200, accordingly, the guide rod 110 constituting the whistle W is accommodated in the socket member 200 so that while the plug member 100 is coupled integrally to the socket member 200, irrespective of the existence of the whistle W, the whistle W is protected sanitary from external dust and foreign substances.

In this case, the central chamber 210 is desirably open on the rear end portion thereof, so that the foreign substances introduced into the central chamber 210 are easily discharged to the outside.

For example, the buckle with the whistle according to the present disclosure is applied to a backpack as shown in FIG. 10, and if an emergency situation occurs during outdoor activities, the plug member 100 is separated from the socket member 200 to allow the whistle W to be immediately used.

In the foregoing specification, embodiments of the present disclosure have been described with reference to specific exemplary embodiments thereof. It will be evident that various modifications may be made thereto without departing from the broader spirit and scope of the present disclosure. According to the present disclosure, For example, the whistle is coupled integrally with the plug member so that a sense of unit is obtained between the buckle and the whistle, without having any addition or interference in the shape of a general buckle. As a result, the buckle with the whistle according to the present disclosure is applicable to different types of buckles used in the conventional practices.

Further, the whistle serves to generate a sound therefrom, and accordingly, unless the whistle interferes with the coupling between the plug member and the socket member, the whistle may have various shapes.

As described above, the buckle with the whistle according to the present disclosure is configured to allow the whistle to be perfectly integral therewith to provide a good outer appearance, without having any different qualities, and to achieve the simplification in manufacturing process and the reduction of the manufacturing cost.

In addition, the buckle with the whistle according to the present disclosure is configured to allow the whistle to be accommodated in the chamber of the socket member so that external dust and foreign substances are prevented from entering the whistle, so that the exposure of the main portions of the whistle to the outside is minimized to ensure the sanitary use of the whistle.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. A buckle with a whistle, comprising:
a plug member having lock arms extending forward from both sides of a base and a guide rod extending forward from the base in such a way as to be located between the lock arms; and
a socket member having a chamber open on the front end thereof by means of an upper plate and a lower plate located to face each other so that the socket member is coupled to the plug member, the chamber is allowed to accommodate the guide rod therein,
wherein the guide rod is configured as the whistle, and when the plug member is coupled to the socket member, the whistle is accommodated in the chamber.

2. The buckle with the whistle according to claim 1, wherein the chamber of the socket member is divided into a central chamber for accommodating the guide rod therein and coupling chambers formed on both sides of the central chamber to insert the lock arms of the plug member thereinto.

3. The buckle with the whistle according to claim 2, wherein the central chamber and the coupling chambers of the socket member are divided by means of partitions, and the inner top and bottom of the central chamber face each other to form a guide groove therebetween so that the guide rod is smoothly inserted into the central chamber through the guide groove.

4. The buckle with the whistle according to claim 1, wherein the whistle comprises:
the guide rod extending integrally from the base of the plug member, having a space portion formed therein, open on the front end portion thereof, and having air ventilation holes formed close to the front end portion thereof to allow the space portion to communicate with the outside; and
a whistle cap fitted to the front end portion of the guide rod to allow a passage to be formed on a portion of the open front end portion of the guide rod.

5. The buckle with the whistle according to claim 4, wherein the guide rod has slant inner surfaces formed on the inner surfaces of the front end portion thereof in such a way as to become enlarged outward therefrom and locking projections protruding from the inner sides of the slant inner surfaces, and the whistle cap has locking portions formed thereon correspondingly to the locking projections, so that the locking portions of the whistle cap are pressurized against the locking projections of the guide rod to allow the whistle cap to come into close contact with the front end portion of the guide rod and be thus coupled to the guide rod.

6. The buckle with the whistle according to claim 1, wherein the plug member or the socket member has a cross bar and a strap hooking bar selectively located on one side of a body thereof to connect a strap or belt thereto.

7. The buckle with the whistle according to claim 1, wherein the plug member or the socket member has a rail holder located on one side of the body thereof.

8. The buckle with the whistle according to claim 1, wherein the plug member or the socket member has a connection member, such as a ring, a clip, a loop, a fastening buckle, a strap connector, and the like, provided integrally with one side of the body thereof.
